(19) United States
(12) Patent Application Publication
(10) Pub. No.: US 2009/0314218 A1
(43) Pub. Date: Dec. 24, 2009

(54) ANIMAL HANDLING APPARATUS

(76) Inventors: Mark Alan Brown, Salisbury (GB); Sean Christopher Hearson, Salisbury (GB); Arthur Allwright, Crayford (GB); Collett Trevor, Crayford (GB)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/443,979

(22) PCT Filed: Sep. 21, 2007
(86) PCT No.: PCT/GB07/03576

§ 371 Date: May 4, 2009

(30) Foreign Application Priority Data
Oct. 5, 2006 (GB) 0619657.0

(51) Int. Cl. A01K 1/03; A01K 1/06

(52) U.S. Cl. 119/473; 119/712

(57) ABSTRACT

Animal handling apparatus comprising a cage (2) with restraining means wherein the restraining means comprises a flexible member (78), such as a net, arranged to restrain an animal in three dimensions when in use. A handler may thereby have access to the animal whilst it is constrained with less risk of movement by the animal and thus less risk of injury to the animal and the handler. The flexible member may be lowered onto or raised from under the animal by means of a chain drive (38) that can be operated by two handles (40) positioned on the outside of the cage.

This invention relates to animal handling apparatus.

When handling animals it is well known to restrain the animal in order to avoid injury to the animal or to the animal handler. For example, a veterinarian may need to restrain an animal whilst providing medical attention to it.

Attempts have been made to design animal management chambers that prohibit an animal's movement inside of the chamber. For example, U.S. Pat. No. 4,367,696 discloses a cat management chamber whereby an adjustable upper partition, positioned above a cat confined within the chamber, can be lowered into the appropriate position for the degree of restraint required thus limiting the cat's vertical movement. Attempts have also been made to design animal restraining cages that limit an animal's lateral movement by pinning an animal between a moveable and a stationary wall, for example the U.S. Pat. Nos. 5,282,441 and 5,441,016.

U.S. Pat. Nos. 5,233,939 and 5,950,566 disclose animal restraining cages that prevent an animal's movement in two dimensions through the use of two movable planar surfaces, for example a moveable ceiling and one moveable wall. Whilst the use of two moveable planar surfaces limits an animal's ability to move about within the cage to a far greater extent than the use of just one moveable planar surface, the animal is still not fully secured. A further disadvantage of such an animal restraining cage is that, by reducing the space in which the animal is contained, the space in which the animal handler can work is decreased making it awkward for the animal handler to, for example, provide medical care.

According to the present invention there is provided animal handling apparatus comprising a cage with restraining means wherein the restraining means comprises a flexible member arranged to restrain an animal when in use.

The invention has the advantage that it can constrain the animal in three dimensions. Furthermore, it allows a handler access to the animal whilst it is constrained with less risk of movement by the animal which may cause injury to the animal and the handler.

An embodiment of the invention will now be described by way of example with reference to the accompanying drawings, in which:

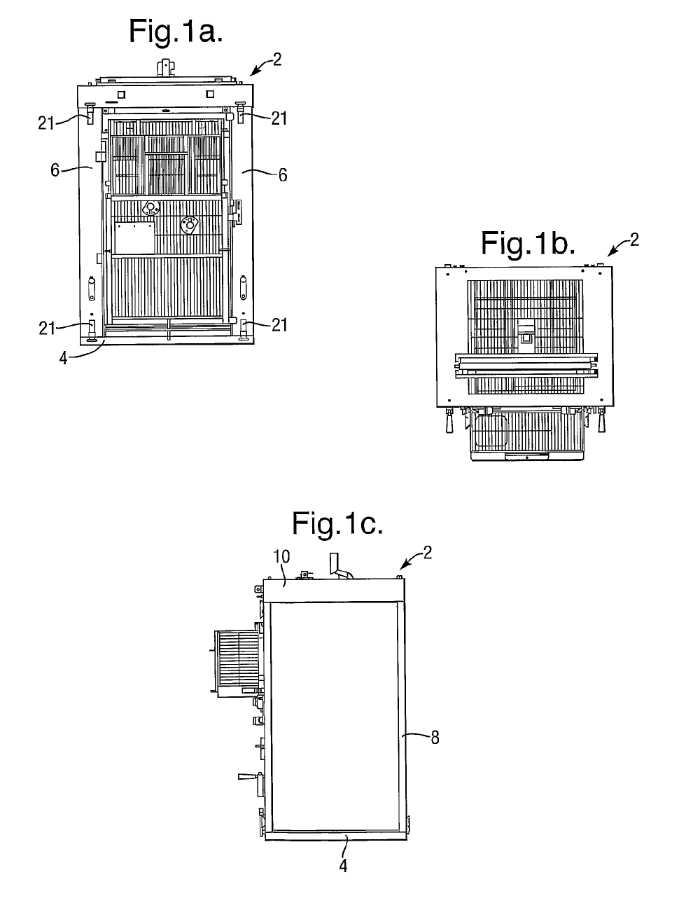

FIG. 1 (a), (b) and (d) are respectively front, top and side views of a animal handling apparatus of this invention;

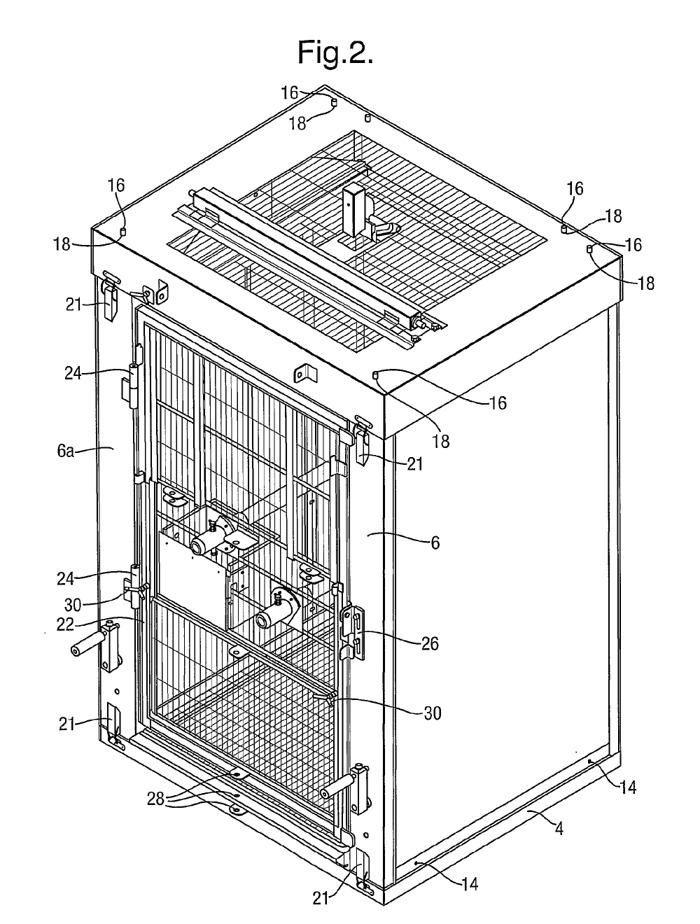

FIG. 2 is a perspective view of the animal handling apparatus shown in FIG. 1;

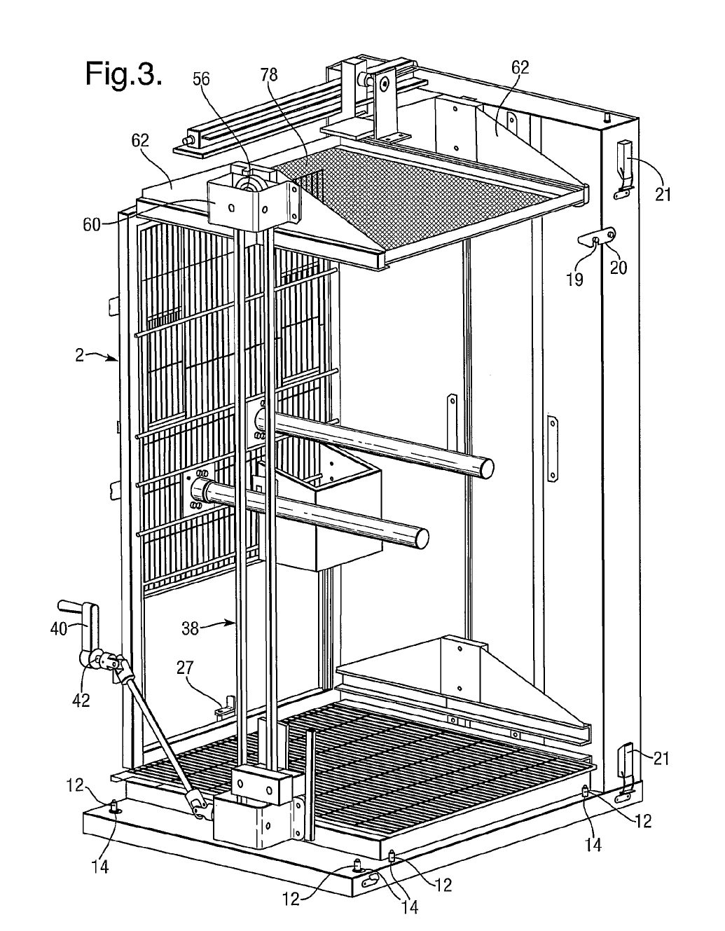

FIG. 3 is a perspective view of the animal handling cage shown in FIG. 1;

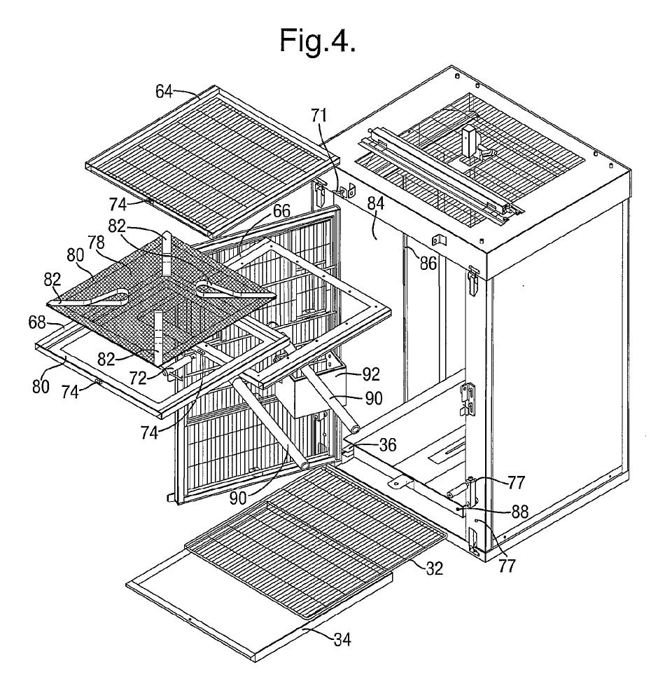

FIG. 4 is a perspective view corresponding to that of FIG. 2;

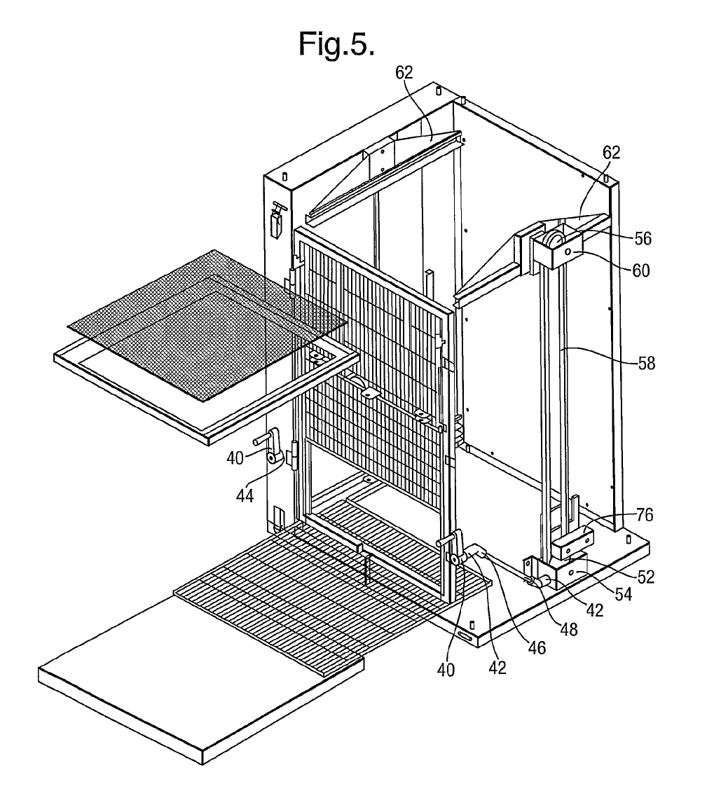

FIG. 5 is a perspective view corresponding to that of FIG. 2;

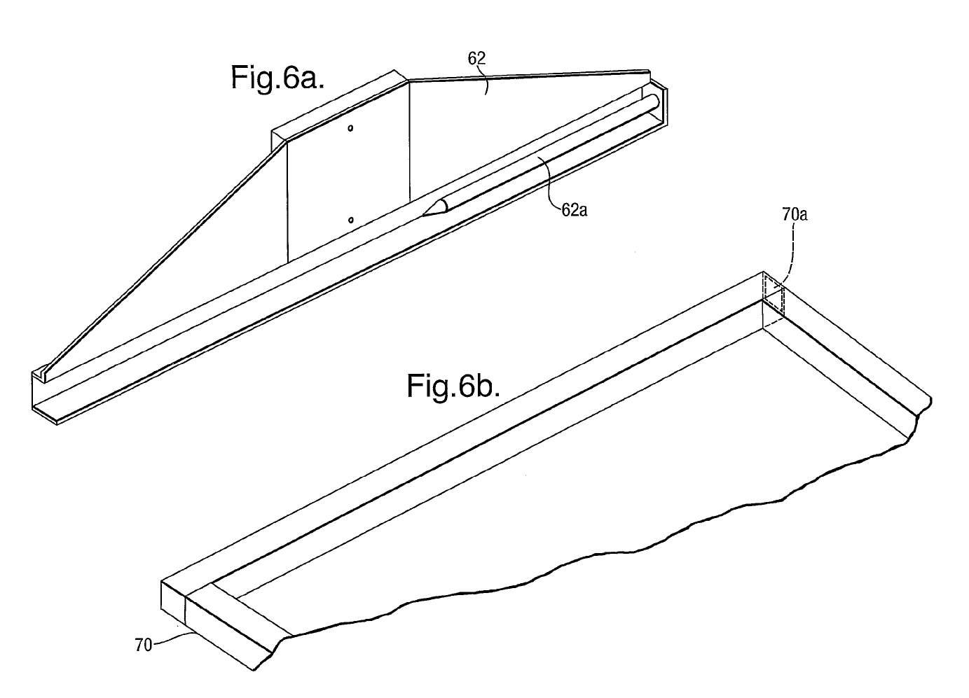

FIG. 6a is a perspective view of a Slide-Out Roof Bracket;

FIG. 6b is a perspective view of an area of a Slide-Out Roof.

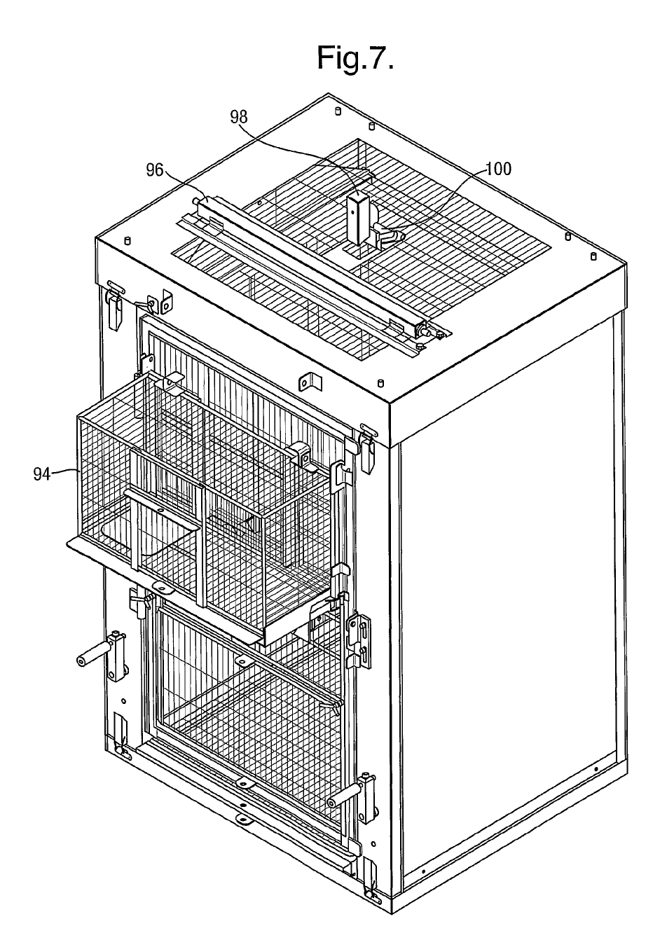

FIG. 7 is a perspective view corresponding to that of FIG. 2;

Referring to FIGS. 1a, 1b and 1c, an animal handling cage 2 comprises a base 4, side walls 6, rear wall 8 and roof 10.

Referring to FIGS. 2 and 3, six lower positioning pins 12 protrude from the base 4 arranged to fit through lower positioning holes 14 in the lower planes of the side walls 6 and the rear wall 8. The side walls 6 and rear wall 8 each have two upper positioning pins 16 that protrude from their upper planes so as to fit through six the upper positioning holes 18 in the roof 10. A hook 19 is attached to each side wall 6 and may be turned so as to hook over two hook pins 20 attached to the rear wall 8. Four clamping enclosures 21 depend from the roof 10, two of which connect to the side wall front panels 6a and 6b and two of which connect to the rear wall 8. Four clamping enclosures 21 also depend from the base 4, two of which connect to side wall front panels 6a and 6b and two of which connect to the rear wall 8.

Access to the inside of the animal handling cage 2 is gained via a door 22 that is fixed to side wall front panel 6a by two hinges 24. When closed, the door 22 is held in position by a latch 26 that is permanently fixed to side wall front panel 6b. The door 22 may be fixed in the closed position by a retaining pin 27 that penetrates three retaining pin holes 28. The lower portion of the door 22 comprises a slide-up door 28 that can be fixed in the open position by tightening two wing nuts 30 thus allowing access to the lower region of the animal handling cage 2.

Referring to FIG. 4, a cage floor 32 is housed within a cage floor tray 34 that is held in position by two cage floor brackets 36 which are fixed to the interior of each side wall 6. The cage floor tray 34 is free to run along the cage floor brackets 36.

Referring to FIGS. 3 and 5, the animal handling cage 2 has a chain drive indicated generally by the reference numeral 38. Two handles 40 are positioned adjacent to the side wall front panels 6a and 6b so that they are on the outside of the animal handling cage 2. A handle spindle 42 protrudes from each handle 40 arranged to penetrate a handle spindle hole 44 located in each side wall front panels 6a and 6b. On the inside of the animal handling cage 2 the handle spindles 42 are connected to universal joints 46, which are connected to spindles 48. The spindles 48 on each side of the animal handling cage 2 are connected to another universal joint 46 at their other end, these universal joints connecting to a bevel gear (not shown) that operates a lower gear 52 on each side of the animal handling cage 2. The lower gears 52 are housed within lower gear casings 54 and are connected to upper gears 56 by two chains 58. The upper gears 56 are housed in upper gear casings 60. Two slide-out roof brackets 62 are connected to the chain drive 38.

Referring to FIGS. 4, 5, 6a and 6b, a rigid slide-out roof 64, or transparent slide-out roof 66, or slide-out flexible net frame 68, each with hollow square-cross-sectional frame 70 containing two holes 70a, may be positioned on the slide-out roof brackets 62. Slide-out roof bracket pins 62a penetrate the holes 70a. A Key 72 fits into key holes 74 and can be used to remove the rigid slide-out roof 64, the transparent slide-out roof 66, or the slide-out flexible net frame 68. A catch 71 can be turned so as to prevent the rigid slide-out roof 64, the transparent slide-out roof 66, or the slide-out flexible net frame 68 from sliding off of the slide-out roof brackets 62 when positioned at the top of the animal handling cage 2. The slide-out roof brackets 62, together with the rigid slide-out roof 64, or the transparent slide-out roof 66, or the slide-out flexible net frame 68, are counter-balanced by counter weights 72 at the opposite extreme of each chain 58. When the two handles 40 are turned concurrently they will lower the rigid slide-out roof 64, or transparent slide-out roof 66, or slide-out flexible net frame 68, whichever is fitted, to the bottom of the animal handling cage 2. The handles 40 may be locked in position by pushing them towards the cage so that they penetrate either of handle locking holes 77.

When the slide-out roof net frame 68 is fitted to the slide-out roof brackets 62 a flexible net 78 may be attached to the frame by Velcro 80. When the two handles 40 are turned concurrently they will lower the slide-out flexible net frame 68, together with the flexible net 78, to the bottom of the animal handling cage 2. The flexible net 78 may be easily removed from the slide-out flexible net frame 68 by pulling on one or more of four straps 82 attached to the flexible net 78.

The animal contained within the animal handling cage 2 is protected from the chain drives 38, and they are protected from them, by chain drive casings 84 that enclose the chain drives 38 arranged so that only a small gap 86 runs along the length of the chain 58. An expanding floor 88 may be placed in the bottom of the animal handling cage 2 and thus provides a smooth surface that reduces the risk of an animal getting caught when the rigid slide-out roof 64, or the transparent slide-out roof 66, or the slide-out flexible net frame 68 is lowered onto it.

Referring to FIGS. 4 and 7, perches 90, a nesting box 92, a play cage 94, a lamp 96 and a camera 98 may be mounted on to the cage. The perches 90 may be removed from outside of the animal handling cage 2. The camera 98 is mounted to the roof 10 by a camera mount 100.

The animal handling apparatus of this embodiment of the invention thus provides a simple means of restraining an animal without causing injury to the animal or the animal handler.

An alternative embodiment of the animal handling apparatus is an animal handling cage in which a flexible net can be lowered onto an animal and affixed to a removable tray at the bottom of the animal handling cage. The tray, animal and flexible net can then be removed from the animal handling cage as one unit.

A further embodiment of the animal handling apparatus is an animal handling cage that contains a net that can be raised from beneath an animal using a chain drive so as to restrain the animal.

Modifications and improvements may be made without departing from the scope of the invention.

1. An animal handling apparatus comprising a cage with restraining means wherein the restraining means comprises a flexible member arranged to restrain an animal when in use.

2. An animal handling apparatus as claimed in claim I wherein there is a lowering means arranged to be capable of lowering the flexible member onto the animal.

3. An animal handling apparatus as claimed in claim 2 wherein the lowering means is a chain drive.

4. An animal handling apparatus as claimed in claim 1 wherein there is a raising means arranged to be capable of raising the flexible member from beneath the animal.

5. An animal handling apparatus as claimed in claim 4 wherein the raising means is a chain drive.

6. An animal handling apparatus as claimed in claim 3 wherein the chain drive is manually operated by a handle located on an exterior surface of the apparatus.

7. An animal handling apparatus as claimed in claim 1 wherein the flexible member is interchangeable with a solid member.

8. An animal handling apparatus as claimed in claim 7 wherein the interchangeable solid member is capable of being lowered by a chain drive.

9. An animal handling apparatus as claimed in claim 8 wherein the chain drive is manually operated by a handle located on an exterior surface of the apparatus.

10. An animal handling apparatus as claimed in claim 1, wherein the flexible member is capable of being attached to a removable floor such that the flexible member and removable floor form a single removable unit.

11. An animal handling apparatus as claimed in claim 1, wherein the flexible member is attached to a supporting member and is capable of being detached from the supporting member.

12. An animal handling apparatus as claimed in claim 1, wherein the flexible member is capable of being partially detached from the supporting member.

13. An animal handling apparatus as claimed in claim 12 wherein the flexible member is attached to the supporting member by Velcro.

14. Method of restraining an animal comprising steps of:
ii. inserting the animal into an animal handling apparatus; and
iii. lowering a flexible member onto the animal

15. (canceled)
